(19) United States
(12) Patent Application Publication
(10) Pub. No.: US 2010/0042487 A1
(43) Pub. Date: Feb. 18, 2010

(54) Apparatus and Method of Monetizing Hyperlinks

(76) Inventor: Yosef Barazani, Bnei-Zion (IL)

Correspondence Address: The Law Office of Michael E. Kondoudis, 888 16th Street, N.W., Suite 800, Washington, DC, 20006, US

(21) Appl. No.: 12/539,043

(22) Filed: Aug. 11, 2009

Related U.S. Application Data
(60) Provisional application No. 61/088,206, filed on Aug. 12, 2008.

(51) Int. Cl. G06Q 30/00; G06N 5/02; G06Q 50/00; G06F 15/173

(52) U.S. Cl. 705/14.13; 706/47; 705/14.16; 709/224

(57) ABSTRACT

A data processing system for monetizing referring hyperlinks from source websites to target websites, wherein the source website owners and target website owners are not associated in business relationship related to referrals. One data processing system comprises a dedicated network server comprising a monitoring module arranged to monitor and record activation of the referring hyperlinks; a benefit value evaluation module, arranged to assign a suggested value to the referring hyperlinks based on predefined rules that relate to the activation of the referring hyperlinks; characteristics of the target websites and the source websites; and statistical data relating to past activation of the referring hyperlinks and related transferred benefit values, and a benefit transaction network platform arranged to support transferal of benefits from the target website owners to the source website owners. The suggested value is used to estimate and recommend the benefit values.

### CROSS REFERENCE TO RELATED APPLICATIONS

This application claims the benefit of U.S. Provisional Patent Application 61/088,206 filed on Aug. 12, 2008, which is incorporated herein by reference.

### BACKGROUND

1. Technical Field

The present invention relates to the field of Internet, and more particularly, to monetizing hyperlinks.

2. Discussion of Related Art

Prior to setting forth the background of the related art, it may be helpful to set forth definitions of certain terms that will be used hereinafter. The term “organic hyperlink” as used herein in this application, also referred to as referring hyperlinks, unpaid links, content links, natural or editorial hyperlinks, is defined as a hyperlink that is voluntarily included in the content of a website and typically appear in a context relevant to the subject of the content. Unpaid links typically refer the user to another website were additional related information may be found. Organic hyperlinks stand in contrast to paid hyperlinks, which are paid for by an advertiser or sponsor. A first website may use an ad placed on second website to drive traffic to the first website. The usages of the term “website” in the present disclosure are defined in a non-limiting manner as to include any electronic document in any medium that may hold embedded hyperlinks to other electronic documents. For example, web-page rendered in a web browser, e-mail document, document on a personal computer, PDA, or mobile phone. Websites may be part of the Internet, including mobile networks. The term “website owner” as used herein in this application, refers to any entity responsible for at least one aspect associated with the website, such as financing, creation, editing, approval, review, implementation, administration, or any other suitable aspect associated with the website. The website owner may be, for example, the actual owner of the domain, the owner of the content presented on the website (e.g., a blogger). Website owners may further be mobile operators, e.g., using Wireless Application Protocol (WAP).

An important aspect of the Internet and World Wide Web is the interconnection of websites through hyperlinks. A hyperlink is an electronic reference from one electronic media to another electronic media and generally may include any kind of link such as an html hyperlink, an image link, a JavaScript link, and a widget link, for example. The hyperlink can be from any medium to any other medium including web browser, email program, or document on a personal computer, personal digital assistant (PDA), or phone, for example. In general links are accessed by selecting hypertext or a graphical user interface element (widget) such as a button, with a pointing device such as a mouse pointer.

Typically, the aim of a website is to cater to its users. The way that a user finds his or her way to a website is by typing the URL of the website directly into the address box on the navigation bar of the web browser or by clicking on a hyperlink on a website, which directs the user's browser to the desired website. Those hyperlinks are generally either unpaid or paid hyperlinks.

Internet marketing, also referred to as online marketing, is the marketing of products or services over the Internet. This online marketing is typically done through online advertising which is a paid message controlled by a sponsor, merchant, or advertiser. Online advertisement is typically done directly between a publisher and an advertiser (or merchant, for example), or an advertising network. An advertising network is a company that connects websites that want to host advertisements with merchants or advertisers, which want advertisements to run. In general the ad that appears on a publisher website includes a hyperlink to the merchant or advertiser.

Another type of online marketing is affiliate marketing, which is a web-based marketing practice in which a business rewards one or more affiliates for each visitor or customer brought about by the affiliate's marketing efforts. An example of such an affiliate program is Amazon Associates. An affiliate network acts as an intermediary between publishers (affiliates) and merchants' affiliate programs. It allows publishers to find affiliate programs, which are suitable for their website and it helps websites offering affiliate programs to reach its target audience.

There are many compensation methods used for the different types of Internet marketing, including Pay per Click (PPC), Pay per Sale (PPS), Pay per Lead (PPL), Pay per Action (PPA), Pay per Impression (PPI), and Cost per Mille (CPM), to name a few.

Advertising networks in general serve ads, monitor advertising on a publisher's website and share merchant or advertiser revenue for qualified clicks (for a PPC setup) each time a visitor clicks on an ad, for example. For merchants, the services may include providing tracking technology, reporting tools, payment processing, and access to publishers. For publishers, the services may include access to merchants and advertisers, reporting tools, and payment collection.

It is generally known that users don't like Internet ads, finding them distracting or interfering with the user accessing the information for which they are looking. The number of websites is increasing every day and all of them fight for the attention of a limited number of users which ultimately reduces the traffic to a given website.

According to prior art, a user operating a computer running an Internet browser software such as Microsoft Internet Explorer, Apple Safari, or Mozilla Firefox, for example, accesses a publisher website through the Internet. The publisher website may include one or more ads which invite the user to visit a merchant website. An advertising network may place ads on the publisher website, and track referring hyperlinks to the merchant website. Because many browsers include ad blockers, the ads may not be displayed properly or the associated hyperlinks underlying the ads may not function properly, the link from source website may not be active. If the user bypasses the ad on the publisher website and goes directly to the merchant website, the publisher website is not credited with the referral by the merchant website. Additionally, the merchant website may be wasting money on ads that generate little or no traffic or sales.

Additionally, there is an inherent conflict between the ad-based hyperlinks and organic hyperlinks. The income for many websites is dependent on ads placed on their website. Whereas organic hyperlinks, if selected by the website visitor, takes the visitor away from the website without compensation. Some websites have gone so far as to not including any organic links to other websites limiting the visitors' navigation options to ad hyperlinks or internal hyperlinks, for example.

Online tipping and donation are examples of online voluntary payment mechanisms. The Amazon Honor System lets online users show their appreciation by voluntarily paying a website the user is visiting. A visitor clicks on a paybox on a website, is directed to a pay page on amazon.com, enters payment information (or 1-click to pay), and Amazon pays the website. Amazon charges a transaction fee for this service.

One system that tracks the individual user's visits to participating web sites and sends to the user a monthly report showing that activity together with a suggested donation amount based on their level of activity and the donations of others for comparable activity is the WorthRight system. The contribution is divided among the various sites the individual user visited over the month, and pro-rated by frequency of visits.

Users visit a site anonymously. The users register once with WorthRight using their email address only and that email address is used only for monthly reporting. No advance payment is required. The visitor to the site takes 15 seconds to register their email address with WorthRight on their first visit to the site. The goal is to make the registration process quick, painless, worry-free, without obligation and of course, private.

The monthly report to the user shows not only which participating sites were visited but how often. A recommended donation amount is divided among those sites based on activity levels. The user can optionally add an additional amount of donation to any site shown. While there is no requirement to make that contribution, WorthRight demonstrates the “accepted level” of donation by showing comparables. The purpose of the monthly report is to bring in contributions.

The following patents and patent applications are incorporated herein by reference in their entirety: U.S. Patent Publication No. 20030023687, which discloses a system, method and storage medium for generating a commission link; U.S. Patent Publication No. 20060080239, which discloses a system and method for pay-per-click revenue sharing; U.S. Patent Publication No. 20060265283, which discloses a system and method for monetizing Internet usage; U.S. Pat. No. 6,449,765, which discloses a varying web page link based on user and web page status; U.S. Patent Publication No. 20020120568, which discloses a user-to-user payment service with payee-specific pay pages; U.S. Patent Publication No. 20020120567, which discloses hosted services for collecting payments from and providing personalized content to web site visitors; U.S. Patent Publication No. 20080300974, which discloses a flexible revenue sharing and referral bounty system; and U.S. Pat. No. 6,029,141, which discloses an Internet-based customer referral system.

### BRIEF SUMMARY

Embodiments of the present invention provide a data processing system for monetizing referring hyperlinks from a plurality of source websites associated with source website owners to a plurality of target websites associated with target website owners, wherein the source website owners and target web site owners are not associated in business relationship related to referrals. One data processing system comprises: a dedicated network server and a benefit transaction network platform. The dedicated network server comprises a monitoring module arranged to monitor and record activation of the referring hyperlinks; a benefit value evaluation module, arranged to assign a suggested value to the referring hyperlinks based on predefined rules, the predefined rules relating to the activation of the referring hyperlinks; and characteristics of the target websites and the source websites; and statistical data relating to past activation of the referring hyperlinks and related transferred benefit values. The benefit transaction network platform is arranged to support transferal of benefits having benefit values from the target website owners to the source website owners, wherein the benefit value is determined by the owner of the target website after the activation of the referring hyperlinks. The suggested value is assigned as an estimate of and a recommendation for the determination of the benefit values.

Accordingly, according to an aspect of the present invention, there is provided a data processing system, wherein the monitoring module is further arranged to collect transactional information from the target website, and wherein the predefined rules, the statistical data and the benefit value further relate to the transactional information, wherein the evaluation module is further arranged to analyze the transactional information in relation to the user actions, and wherein the dedicated network server further comprises a database arranged to receive data relating to the monitored user actions and the transactional data.

Accordingly, according to another aspect of the present invention, there is provided a data processing system, further comprising a decision supporting module associated with the benefit value evaluation module and the benefit transaction network platform and arranged to provide the target website owner with the data relating the process of assigning the suggested value, assisting the target web site owner to determine the benefit values in relation to a conduct code relating to voluntary compensation behavioral patterns.

Accordingly, according to yet another aspect of the present invention, there is provided a data processing system, wherein the dedicated network server further comprises a graphical user interface arranged to present a web link graph comprising connections and benefit transactions between source websites and target websites.

Embodiments of the present invention provide a data processing system for monetizing referring hyperlinks from a plurality of source websites associated with source website owners to a plurality of target websites associated with target website owners, wherein the source website owners and target web site owners are not associated in business relationship related to referring hyperlinks, and wherein the referring hyperlinks were edited by specific users within the source website. One data processing system comprises a dedicated network server comprising: a monitoring module arranged to monitor and record activation of the referring hyperlinks; a benefit value evaluation module, arranged to assign a suggested value to the referring hyperlinks based on predefined rules, the predefined rules relating to the activation of the referring hyperlinks; and characteristics of the target websites and the source websites; and statistical data relating to past activation of the referring hyperlinks and related transferred benefit values, and a benefit transaction network platform arranged to support transferal of benefits having benefit values from the target website owners to the specific users, wherein the benefit value is determined by the owner of the target website after the activation of the referring hyperlinks. The suggested value is assigned as an estimate of and a recommendation for the determination of the benefit values.

Embodiments of the present invention provide a computer implemented method of monetizing referring hyperlinks from a plurality of source websites associated with source website owners to a plurality of target websites associated with target website owners, wherein the source website owners and target web site owners are not associated in business relationship related to referring hyperlinks. One computer implemented method comprises: monitoring activation of the referring hyperlinks; assigning a suggested value to the referring hyperlinks based on predefined rules; and enabling the target web site owner to determine a benefit value related to the referring hyperlinks of a specific source web site, wherein the benefit value relates to the suggested values and is determined after the activation of the referring hyperlinks; providing a benefit transaction network platform supporting transferal of benefits having benefit values from the target website owners to the source website owners, wherein the benefit value is based on the monitored activation of the referring hyperlinks and the assigned suggested value. The predefined rules relate to characteristics of the target websites and the source websites as well as to past activation of the referring hyperlinks, and the suggested value is assigned as an estimate of and a recommendation for the benefit values.

Accordingly, according to an aspect of the present invention, there is provided a computer-implemented method, wherein the monitoring activation of the referring hyperlinks is carried out by the target websites or by setting an application in the source websites.

Accordingly, according to another aspect of the present invention, there is provided a computer-implemented method, further comprising associating source website owners and target website owners in a social network and enhancing the supported benefit transferal.

Accordingly, according to still another aspect of the present invention, there is provided a computer-implemented method, further comprising collecting transactional information from the target websites, the transactional information comprising benefits to the target websites; and analyzing the transactional information such as to relate the transactional information to the activation of the referring hyperlinks. The predefined rules further relate to statistical data relating to past transactional information and suggested values.

Accordingly, according to yet another aspect of the present invention, there is provided a computer-implemented method, further comprising: monitoring user actions in the source websites and in the target websites; and analyzing the transactional information in relation to the user actions. Collecting transactional information from the target websites is further related to the monitored user actions, the benefits relate to the user actions, and analyzing the transactional information comprises statistically analyzing all transactional information from the plurality of target websites in relation to target website characteristics

Embodiments of the present invention provide a data processing system for monetizing referring hyperlinks from a plurality of source websites associated with source website owners to a plurality of target websites associated with target website owners, wherein the source website owners and target web site owners are not associated in business relationship related to referring hyperlinks. One data processing system comprises a dedicated network server comprising: an application arranged to monitor activation of the referring hyperlinks; collect transactional information from the target website; record the transactional information such as to relate it to the activation of the referring hyperlinks; monitor user actions in the source websites and in the target websites; analyze the transactional information in relation to the user actions; and assign a suggested value to the referring hyperlinks in relation to the user actions and activation of the referring hyperlinks; the transactional information; predefined rules; external sources; past benefits and the target websites; a database arranged to receive data relating to the monitored activation of referring hyperlinks, monitored user actions, and transactional information; a benefit transaction network platform arranged to support transferal of benefits having benefit values from the target website owners to the source website owners, wherein the benefit value is based on the monitored activation of the referring hyperlinks and the assigned suggested value; a decision supporting module associated with the benefit value evaluation module and the benefit transaction network platform and arranged to provide the target owner with the data relating the process of assigning the suggested value, assisting the target web site owner to determine the benefit values in relation to a conduct code relating to voluntary compensation behavioral patterns; a transactional platform associated with the dedicated network server and arranged to allow source website owners and target website owners to benefit each other; and a graphical user interface arranged to present a web link graph comprising connections and benefit transactions between source websites and target websites. The predefined rules relate to characteristics of the target websites, the source websites and statistical data relating to past transactional information and suggested values, and related transferred benefit values. The suggested value is assigned as an estimate of and a recommendation for the benefit values.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the accompanying drawings of which:

FIG. 1 is a high level schematic block diagram of a data processing system for monetizing referring hyperlinks, according to some embodiments of the invention;

FIGS. 2A and 2B are high-level schematic flowcharts of a computer-implemented method for monetizing referring hyperlinks according to some embodiments of the invention; and

FIG. 3 is a high-level schematic block diagram of a data processing system for monetizing recommendations using referring hyperlinks in a social network, according to some embodiments of the invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

For a better understanding of the invention, the usages of the term “user” in the present disclosure is defined in a non-limiting manner as either a real person, a website owner, or any entity that interacts with websites or content such as content consumers, content editors and content generators—in own websites or other websites. When the user is another website owner his hyperlink and content may be included in source website for example by syndication or other means automatic or by hand. Any hyperlink that is put by a user will be associated with a user ID in addition to source website ID.

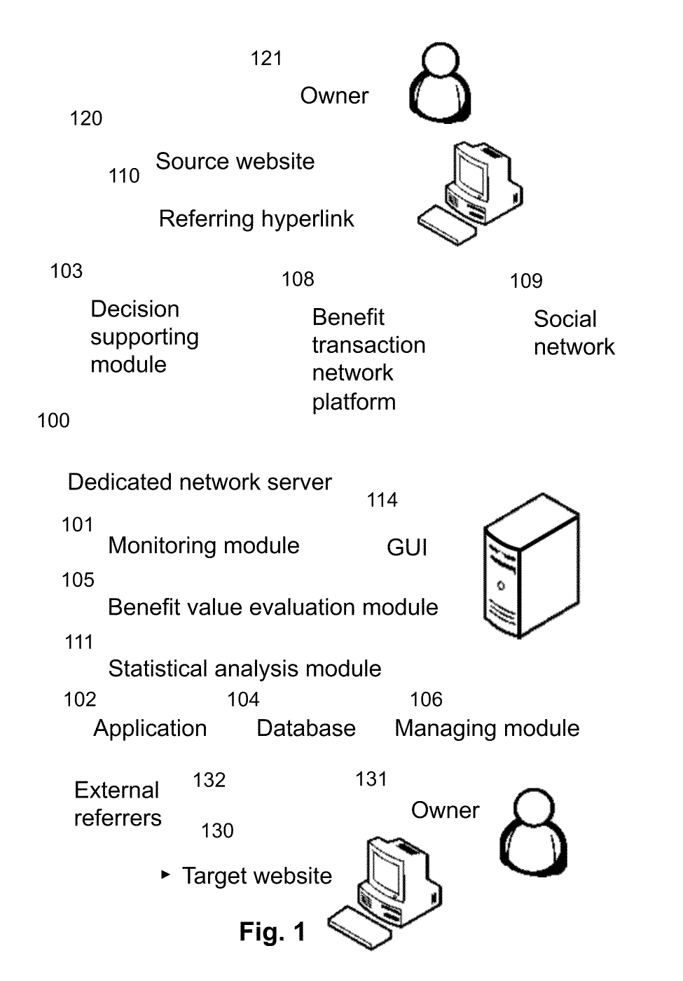

FIG. 1 is a high-level schematic block diagram of a data processing system for monetizing referring hyperlinks 110, according to some embodiments of the invention. Referring hyperlinks 110 direct from source websites 120 associated with source website owners 121 to target websites 130 associated with target website owners 131, wherein the source website owners and target web site owners are not associated in business relationship related to referring hyperlinks. The data processing system comprises a dedicated network server 100 arranged to: monitor and record activation of referring hyperlinks 110; optionally monitor user actions in source websites 120 and in target websites 130; optionally collect transactional information from target website 130 relating to the monitored user actions; optionally analyze the transactional information such as to relate the transactional information to the activation of referring hyperlinks 110; and assign a suggested value to referring hyperlinks 110 based on predefined rules, that relate to the activation of referring hyperlinks 110, characteristics of target websites 130 and source websites 120, and statistical data relating to past activation of referring hyperlinks 110. Optionally, the suggested value may further be assigned in relation to transactional information and user actions. The assigned suggested value may be assigned as an estimate of and a recommendation for the benefit values to target websites 130 and serve as a recommendation for the benefit transferal to source websites 120, after the activation of referring hyperlinks 110.

According to some embodiments of the invention, the suggested value is assigned in relation to external sources for rating websites. External sources may comprise website ranking, and external pricing data such as price per click for similar keywords included in link/source/target.

According to some embodiments of the invention, dedicated network server 100 may comprise a monitoring module 101 arranged to monitor and record activation of referring hyperlinks 100, and a benefit value evaluation module 105, arranged to assign a suggested value to referring hyperlinks 110 based on predefined rules, the predefined rules relating to the activation of referring hyperlinks 110; characteristics of target websites 130 and source websites 120; and statistical data relating to past activation of referring hyperlinks 110 and related transferred benefit values. Optionally dedicated network server 100 may further comprise a statistical analysis module 111 arranged to collect and analyze statistical data relating to past activation of referring hyperlinks 110 and related transferred benefit values.

According to some embodiments of the invention, dedicated network server 100 may comprise an application 102, a database 104 and a managing module 106 arranged to operate dedicated network server 100 and generate various relating data. Dedicated network server 100 may further comprise a benefit transaction network platform 108 arranged to support transferal of benefits having benefit values from target website owners 131 to source website owners 121. The benefit value may be based on the monitored activation of referring hyperlinks 110 and the assigned suggested value, and optionally also on the transactional information, the predefined rules and the user actions. The predefined rules may relate to characteristics of target websites 130 and the statistical data, and the assigned suggested value is derived such as to estimate the benefits to target websites 130 and serve as a recommendation for the benefit transferal to source websites 120. For example, the benefits from referring hyperlinks 110 may differ among target websites 130—some target websites owners 131 benefit from sales, while others benefit from advertising income relating to traffic, and still further target website owners 131 benefit from establishing themselves as frequently visited websites.

According to some embodiments of the invention, the past activation of referring hyperlinks 110 may comprise activation of referring hyperlinks 110 in various source websites 120, and related statistical data, which may be analyzed in various ways.

According to some embodiments of the invention, referring hyperlinks 110 were edited by specific users within source website 120. Benefit transaction network platform 108 may be arranged to support transferal of benefits having benefit values from target website owners 131 to the specific users. Benefits may be transferred to the specific users either directly or through source website owners 121.

According to some embodiments of the invention, analyzing the transactional information may comprise statistically analyzing all transactional information from target websites 130 in relation to target website characteristics. The statistical analysis may relate to all transactional and referral data in database 104, including a multitude of websites, and used to derive an estimated compensation or benefit to specific cases.

According to some embodiments of the invention, compensations may relate to any of: impressions, clicks, anchor text keywords, category of source, category of target, user actions on source websites 120, action on target websites 130 such as sales, leads, time on site, etc., a quality score of source website 120, that may be taken from external ranking data (how well his traffic was converted in the past), a trust score of source website 120 (high score indicating better traffic), pay per click comparable price from external data sources, benefits to other source websites 120 and target websites 130 in the system.

According to some embodiments of the invention, dedicated network server 100 may be further arranged to report target websites 130 of the transactional information that is related to the activation of referring hyperlinks 110 at source websites 120, wherein the transaction itself is carried out at target websites 130. According to some embodiments of the invention, this report is implemented using a Pixel Image method. Alternatively, target websites 130 may collect transactional information and send in to dedicated network server 100 in relation to referring hyperlinks 110. A further embodiment includes injecting an application such as a cookie to computers supporting source websites 120 and to target websites 130 that reports dedicated network server 100 of hyperlink references and transactions.

According to some embodiments of the invention, the data processing system may further relate external referrers 132 (e.g., physical advertisements, newspaper articles) recommending target website 130 or target website owners 131 to the system, such as allowing external referrers 132 to register to dedicated network server 100 and be included in benefit transaction network platform 108.

According to some embodiments of the invention, dedicated network server 100 may further comprise a graphical user interface (GUI 114) arranged to allow users and website owners to view, estimate and analyze benefits in relation to referring hyperlinks 110. GUI 114 may be further arranged to generate benefit transaction graphs that illustrate graphically connections between source websites 120 and target website 130, as well as benefit transactions between them, and various statistical measures related thereto.

According to some embodiments of the invention, the system implements a voluntary payment mechanism for organic hyperlinks. It supports and encourages a voluntary transferal of payments according to a perceived commercial value of organic hyperlinks and according to a community valuation of organic hyperlinks.

According to some embodiments of the invention, the data processing system may further comprise a decision supporting module 103 associated with benefit value evaluation module 105 and benefit transaction network platform 108 and arranged to provide target source websites 130 with the data relating the process of assigning the suggested value, assisting target web site owner 131 to determine the benefit values in relation to a conduct code relating to voluntary compensation behavioral patterns. Such conduct code may comprise common payments and payment rules, various modes of compensation such as back referral, models for determining compensations, suggested values and so forth.

According to some embodiments of the invention, benefit transaction network platform 108 is associated with dedicated network server 100 and arranged to allow source website owners 121 and target website owners 131 to benefit each other, e.g., in relation to the suggested values. Benefit transaction network platform 108 may comprise or be associated with a voluntary payment mechanism suggesting compensation values, providing statistical data relating to common compensations and benefits and referring to them as a common conduct code. The voluntary payment mechanism may encourage voluntary benefiting source website owners 121.

According to some embodiments of the invention, a social network 109 may allow in connection with dedicated network server 100 to generate new connections and recommendations between entities relating to source websites 120 and target websites 130.

According to some embodiments of the invention, benefits may be diverted from either source website 120 or target website 130 to a third party. For example, a publisher may decide to donate his share to eliminate any conflict, or an advertiser may decide not to pay the publisher but donate the benefit to a third party/

According to some embodiments of the invention, dedicated network server 100 may generate cross-site analytics. Target websites 130 may get statistics and analytics relating to source websites 120 (e.g., number of unique visitors, time on the site, demographic data) and also analytics and statistics about the traffic referrer to source websites 120.

According to some embodiments of the invention, data processing system may further comprise social network 109 associating source website owners 121 and target website owners 131 and enhancing the supported benefit transferal. Social network 109 may allow for example discuss suggested values, provide information and request concerning new products and changes in commercial relations, report successful usage of referring hyperlinks 110. Social network 109 may enhance the voluntary payment mechanism and thus support the functioning of the data processing system.

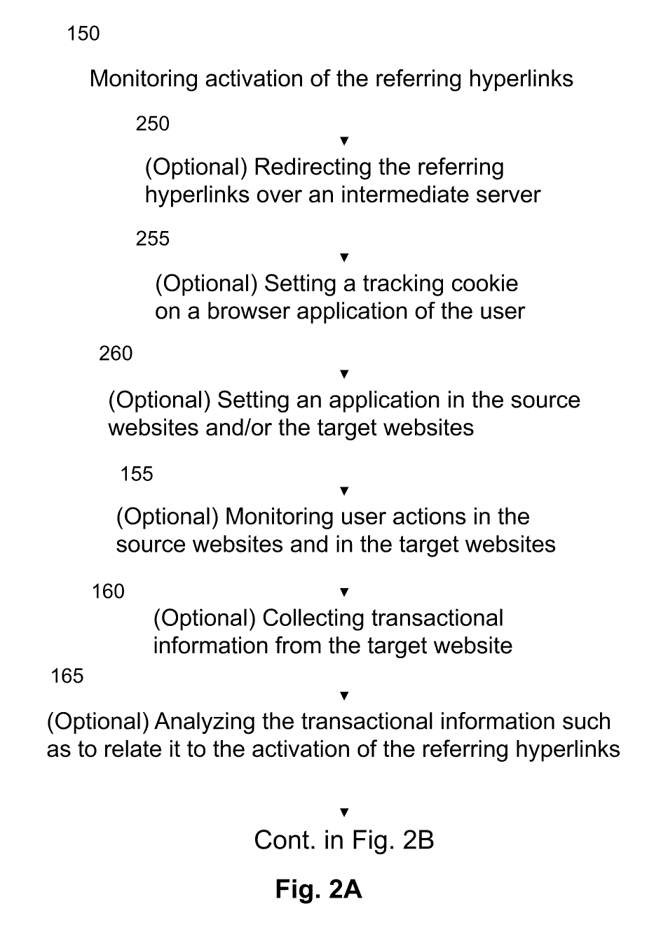

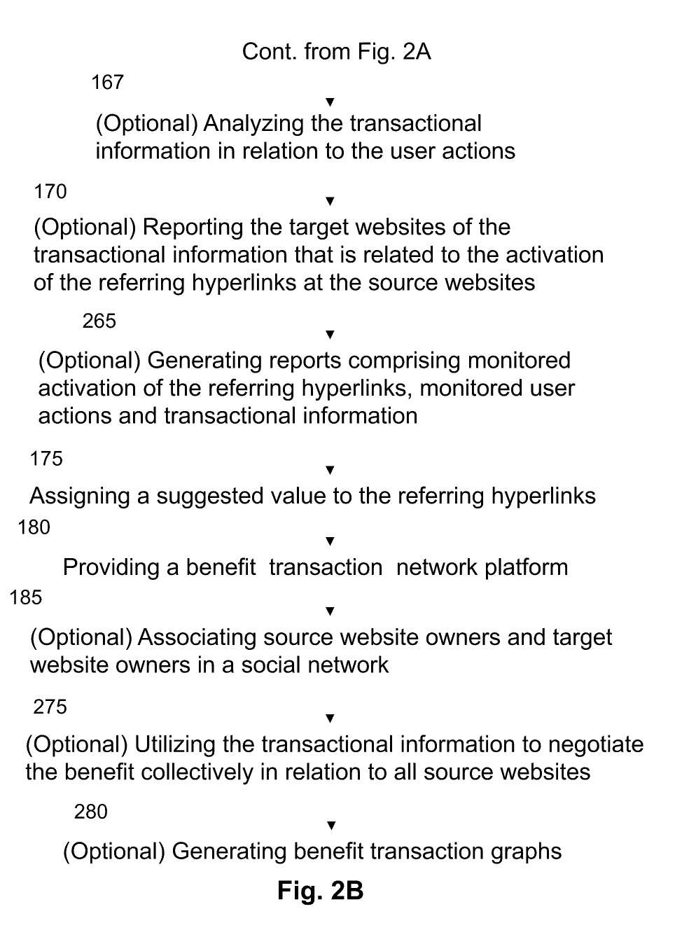

FIGS. 2A and 2B are high-level schematic flowcharts of a computer-implemented method for monetizing referring hyperlinks according to some embodiments of the invention. The referring hyperlinks direct from source websites associated with source website owners to target websites associated with target website owners. The source website owners and target web site owners are not associated in business relationship related to referring hyperlinks. The computer-implemented method comprises the stages: monitoring activation of the referring hyperlinks (stage 150); optionally monitoring user actions in the source websites and in the target websites (stage 155); optionally collecting transactional information (comprising benefits to the target websites that relate to the source websites, activation of the referring hyperlinks and user actions) from the target websites (stage 160) optionally relating to the monitored user actions; analyzing the transactional information such as to relate it to the activation of the referring hyperlinks (stage 165) and optionally in relation to user actions (stage 167); optionally reporting the target websites of the transactional information that is related to the activation of the referring hyperlinks at the source websites (stage 170), if the target websites do not collect the transactional themselves or can relate it to incoming hyperlinks; assigning a suggested value to the referring hyperlinks (stage 175), e.g., in relation to transactional information and to the target websites, and providing a benefit transaction network platform (stage 180), supporting benefit transferal of benefits having benefit values from the target website owners to the source website owners in relation to the referring hyperlinks, the assigned suggested value, and the predefined rules, after the activation of the referring hyperlinks. The benefit value may be based on the monitored activation of the referring hyperlinks and the assigned suggested value, as well as on transactional information, predefined rules and user actions. The predefined rules may relate to characteristics of the target websites and the source websites, as well as statistical data relating thereto, and the assigned suggested value is derived as an estimate of and a recommendation for the benefit values. For example, the benefits from the referring hyperlinks may differ among target websites—some target websites owner may benefit from sales, while others benefit from advertising income relating to traffic, and still further target website benefit from establishing themselves as frequently visited websites. According to some embodiments of the invention, the computer-implemented method may further comprise associating source website owners and target website owners in a social network (stage 185) and enhancing the supported benefit transferal.

According to some embodiments of the invention, analyzing the transactional information (stage 165) may comprise statistically analyzing all transactional information from the target websites in relation to target website characteristics. The statistical analysis may relate to all transactional and referral data in database 104, including a multitude of websites, and used to derive an estimated compensation or benefit to specific cases.

According to some embodiments of the invention, monitoring user actions in the source websites and in the target websites (stage 155) may be carried out by redirecting the referring hyperlinks over an intermediate server (stage 250). Monitoring user actions (stage 155) may be carried out by setting a tracking cookie on a browser application of the user (stage 255). Monitoring activation of the referring hyperlinks (stage 150) may be carried out by the target websites. Monitoring activation of the referring hyperlinks (stage 150) may alternatively of complementary be carried out by setting an application in the source websites and/or in the target websites (stage 260). Monitoring user actions (stage 155) may be carried out by setting an application in the source websites and in the target websites (stage 260).

According to some embodiments of the invention, monitoring user actions (stage 155) may exploit tracking technologies such as overriding existing links and replacing them with links to a tracker, i.e., redirecting links, various user action reporting methods (e.g. AJAX based), and URL replacement services.

According to some embodiments of the invention, the computer-implemented method may further comprise generating reports comprising at least parts of: the monitored activation of the referring hyperlinks, monitored user actions and transactional information (stage 265). According to some embodiments of the invention, the computer-implemented method may further comprise utilizing the transactional information to negotiate the benefit collectively in relation to all source websites (stage 275).

According to some embodiments of the invention, the computer-implemented method may further comprise generating benefit transaction graphs (stage 280) that illustrate graphically connections between the source websites and the target website, as well as benefit transactions between them, and various statistical measures related thereto.

According to some embodiments of the invention, the system and method enable voluntarily compensating owners 121 of source websites 120 for their nonpaid (organic) hyperlinks by owners 131 of target websites 130. When a user visits source website 120 and accesses or is redirected to target website 130, owner 131 of target website 130 is presented with the opportunity to voluntarily compensate owner 121 of source website 120. Dedicated network server 100 tracks referring hyperlinks 110 from source websites 120 to target websites 130, provides reports, collects voluntary compensations from owners 131 of target websites 130, distributes aggregate compensations to owners 121 of source websites 120 and allows implicit bidding (auction) between owners of target websites 130.

According to some embodiments of the invention, a tracked hyperlink from source website 120 is displayed by the browser software on the user's computer. The hyperlink may be a text link, graphic link, image link, or the like. The hyperlink is tracked by dedicated network server 100. Referring hyperlinks 110 may be redirected from source websites 120 over an intermediate server (e.g. dedicated network server 100) to target websites 130. In some embodiments, this may follow a request from a user to access dedicated network server 100 by clicking on a hyperlink on source website 120, directing the user to dedicated network server 100, setting a tracking cookie on the visitor's web browser, the tracking cookie including source website 120 tracked hyperlink identifier, redirecting the visitor's browser to target website 130, and allowing the user to conclude the required action on target website 130. Target website 130 may report page requests, purchases made by the user, or other transactions such as filling-out a form, downloading a file, or clicking on an ad, for example, to dedicated network server 100. Dedicated network server 100 can also record page views and clicks without transaction data from target website 130.

According to some embodiments of the invention, dedicated network server 100 then checks the user's web browser for a previously set cookie and, if the cookie is found, dedicated network server 100 writes the transaction into dedicated network server 100 database 104. Dedicated network server 100 generates a report for each target website 130 that includes all source websites 120 that referred users to target website 130 with details about page views, clicks, transactions and the like. Other information provided by dedicated network server 100 may include a suggested compensation benefit based on page views, transactions, and compensation levels of others. The benefit may comprise a payment, a reciprocal service or any other form, material or virtual. Each owner 131 of target website 130 may decide to voluntary compensate owner 121 of source website 120 for the referred users. Dedicated network server 100 generates a report for each source website 120 that lists its referred traffic and aggregates the compensations from all target websites 130. Dedicated network server 100 may collect compensations from owners 131 of all target websites 130 and distribute them to owners 121 of source websites 120. Dedicated network server 100 may charge a fee or keep a portion of those compensations as a service fee. Dedicated network server 100 generates a compensation report that includes comparable benefits and compensations (in absolute or proportional terms) from any owner 131 of target website 130 to any owner 121 of source website 120. This report encourages implicit auction (bidding) mechanism between owners 131 of target websites 130 to increase their payout.

Dedicated network server 100, while working as an aggregator of source websites 120 on one side and target websites 130 on the other side, may have greater power in “negotiating” a compensation from owners 131 of target website 130, and motivating owners 131 of target websites 130 to join dedicated network server 100 and compensate owners 121 of source websites 120 voluntary than one to one relationships among owners 121 of source websites 120 and target websites 130. Dedicated network server 100 tracks aggregate link referrals (clicks) from source websites 120 to target websites 130 that are not part of dedicated network server 100. By exposing that data to source websites 120, community and to target websites 130, it may influence the decision of target websites 130 to join dedicated network server 100.

According to some embodiments of the invention, the invention provides an environment and an architecture that includes dedicated network server 100. A user accesses a computer, which includes a processor coupled to a computer-readable medium, such as random access memory. The processor executes program instructions stored in memory such as web browser software. Other devices may be coupled to the computer such as external or internal hard drives, a mouse, a CD-ROM, a keyboard and display, for example. Other devices may be used by the user such as personal computers, personal digital assistants, mobile phones, or content players, for example.

According to some embodiments of the invention, the user may visit source website 120 by entering the uniform resource locater (URL) of source website 120 directly into address line of the web browser. Alternatively, the user may have “surfed” to source website 120 by clicking a link from another website, or a search engine, for example. Source website 120 may include one or more organic links, which may include a word or phrase, an image or an icon, for example, with an associated underlying or embedded hyperlink. Typically, the mouse pointer changes to a hand icon to indicate that an area on the display is active or selectable. A word or phrase may also be displayed as a different color from the surrounding text, or underlined to indicate that the text has an associated hyperlink. By clicking on a tracked textual or graphic hyperlink, the associated URL directs the user's web browser to dedicated network server 100. For example, the URL usually contains the ID number for the referring site, the ID number for target website 130, and the URL of target website 130.

According to some embodiments of the invention, dedicated network server 100 is an intermediary party that tracks selection of the associated hyperlinks from source website 120. Dedicated network server 100 records a click on that URL and redirects the user to target website 130. This may happen so quickly that the user may never notice dedicated network server 100 in the browser window. Many source websites 120, which include organic hyperlinks, and one or more hyperlink network servers 100 may be interconnected with one or more target websites 130 via a network such as the Internet.

According to some embodiments of the invention, when a user selects an organic link (e.g., referring hyperlink 110) on a source website 120, the user is routed to dedicated network server 100. Dedicated network server 100 records the click in the database and sets a tracking cookie on the user's computer. Dedicated network server 100 includes a processor and memory. Dedicated network server 100 then redirects the user to target website 130 landing page. Referral information such as information to identify source website 120 or dedicated network server 100, for example, may be included in the redirection of the user to target website 130. Target websites 130 may set a tracking cookie on the user's computer, which may include dedicated network server 100 and/or source website 120 information.

According to some embodiments of the invention, once the user has concluded any action on target website 130, target website 130 may report page requests and purchases made by the user to dedicated network server 100. Usually a single pixel image request, which includes parameters that report data about the sale or other event to dedicated network server 100 directing dedicated network server 100 to check for the presence of the tracking cookie. Alternatively, target website 130 may redirect the user over a link back to dedicated network server 100, which may then read the tracking cookie information previously set by dedicated network server 100. If redirected, dedicated network server 100 then checks the user's computer for a previously set dedicated network server cookie containing source website 120 tracked hyperlink identification. If a cookie is found, dedicated network server 100 records the transaction, including source website 120 hyperlink identification, transaction identification, and other information, into dedicated network server database 104. Database 104 may be accessible by source website 120 and target website 130 so that each party can see the number of hyperlinks served, clicked, leads, sales or any other recorded action.

According to some embodiments of the invention, target website 130 may use database 104 to voluntary decide which owners 121 of source websites 120 to compensate for their referrals. Additionally, dedicated network server 100 can generate a compensation report that includes comparable benefits and compensations (in absolute or proportional terms) from any owner 131 of target website 130 to any owner 121 of source website 120. This report may encourage implicit auction (bidding) mechanism between owners 131 of target websites 130 to increase their payout. Owners 131 of target website 130 may transfer compensations directly to dedicated network server 100, which are then separated as directed by target website 130, and aggregated and distributed to each owner 121 of identified source website 120. Dedicated network server 100 may keep a share (commission) from the compensation for its service or charge owners 131 of target websites 130 or owners 121 of source websites 120 a fee for the service.

According to some embodiments of the invention, the process begins by a user visiting a source website 120. Source website 120 sets a cookie on the user's computer. If the user selects an organic link present on source website 120, the user is redirected to dedicated network server 100. Dedicated network server 100 sets a tracking cookie on the user's computer, records the click in the database, and redirects the user to target website 130. The user then interacts with target website 130. Once the user leaves target website 130 or completes any transaction, target website 130 may send information to dedicated network server 100. Dedicated network server 100 provides benefits to target website 130. Dedicated network server 100 collects compensations from target website 130 and distributes the contributions to source websites 120 as directed. Dedicated network server 100 generates referral and contribution reports to be sent to or accessed by source websites 120 and target websites.

According to some embodiments of the invention, there is provided a method of increasing the inbound link credit of target websites 130. Source website 120 links directly to target website 130 (no redirect through dedicated network server 100), so that all of source website 120's hyperlinks directed to target website 130 contribute to target website 130 inbound link credit. Target website 130 parses the incoming web page requests, and extracts the referrer information. Target website 130 directly or via dedicated network server 100, accesses a database of source websites 120 to determine whether source website 120 belongs to dedicated network server 100. If so, owner 121 of source website 120 is credited for the traffic, and may additionally be credited for user activity at target website 130. Dedicated network server 100 may write a cookie to the user's computer to further track the user through dedicated network server 100.

According to some embodiments of the invention, all the data is written into database 104, which target website 130 may access to determine which source websites 120 to compensate for their referrals. Dedicated network server 100 then collects the compensations from all owners 131 of target websites 130, aggregates the compensations for each owner 121 of source website 120 and distributes the compensation to owners 121 of source website 120. Dedicated network server 100 may deduct a commission from the compensation for its service.

According to some embodiments of the invention, there is provided a method of a dedicated network server which also increases the inbound link credit of target websites 130 is presented. A source website 120 links directly to a target website (no redirect through dedicated network server 100), so that all of a source website 120's hyperlinks directed to a target website contribute to target website 130 inbound link credit. Source website 120 installs dedicated network server 100's JavaScript code on its website. Dedicated network server 100's JavaScript automatically changes direct target links that appear on source website 120 into redirecting tracking links. Dedicated network server 100 sets a tracking cookie on the user's web browser. Dedicated network server 100 then redirects the user's browser to target website 130 landing page. After the user concludes any action on target website 130, target website 130 may report page requests and purchases made by the user to dedicated network server 100. Dedicated network server 100 then checks the user's browser for a previously set dedicated network server cookie containing source website 120 tracked hyperlink identification. If a cookie is found, dedicated network server 100 saves the transaction, including source website 120 hyperlink identification, transaction identification, the amount (if a sale took place) and other information into a database. This database is accessible by both source website 120 and target website 130 so that each party can see the number of hyperlinks served, clicked, leads, sales or any other information generated.

According to some embodiments of the invention, a source website 120 in dedicated network server 100 may include a java script supplied by dedicated network server 100 that allows dedicated network server 100 to track a user's activities on source website 120 including pages viewed and hyperlinks clicked, for example. Source website 120 links directly to target website 130 (no redirect through dedicated network server 100), so that all of source website 120's referring hyperlinks 110 directed to target website 130 contribute to target website 130 inbound link credit. Target website 130 can communicate with dedicated network server 100 for source website 120 validation and user activity on target website 130. Dedicated network server 100 writes the traffic data of referral hyperlinks 110 to the database which target website 130 can use to determine which source websites 120 to compensate. Dedicated network server 100 then collects the compensations from all owners 131 of target websites 130, aggregates the compensations for each owner 121 of source website 120 and distributes them to owners 121 of source website 120.

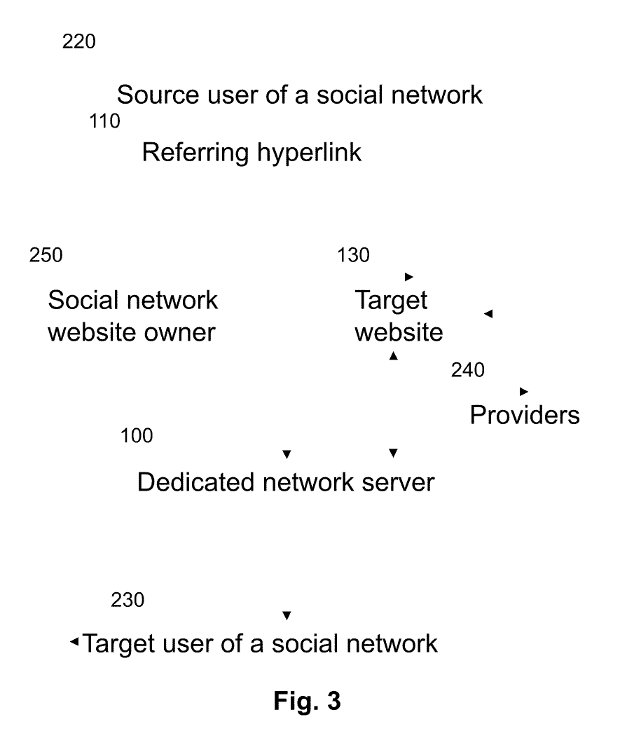

FIG. 3 is a high-level schematic block diagram of a data processing system for monetizing recommendations using referring hyperlinks 110 in an Internet based social network, according to some embodiments of the invention. Source users 220 may generate referring hyperlinks 110 to target websites 130 (e.g., recommendations of various providers 240 associated with target websites 130), and publish them to target users 230 in the social network website. Dedicated network server 100, may record referring hyperlinks 110 and track their benefit to provider target websites 130. The data processing system may monetize referring hyperlinks 110 in relation to source users 220 generating referring hyperlinks 110. For example, the data processing system may monetize recommendations in relation to source users 220 generating the recommendation. For example, dedicated network server 100 may track reports of target users 230. Then, providers 240 may be prompted to compensate or benefit source users 220, as well as a social network website owner 250. Recommendations 210 may be assigned a suggested value related to the transactions they create.

In social networks such as Facebook and MySpace, for example, users connect and interact with other users. People active on a social network generally don't engage in traditional ads no matter how contextually relevant they may be. Generally, the users are focused on communicating with each other, not looking at content with some hopefully relatively relevant ads attached. Any advertising in that context is generally an annoying interruption and likely a waste of money. In some embodiments, the system creates incentives for people/customers/users to promote services or products of providers 240 such as other users of the social network. Through the use of organic hyperlinks and voluntary compensation, the users of the social network are encouraged to recommend to each other the brands, services, and products that they like, and at the same time get compensated for recommendations. For example, a social network member may take a cell phone picture of herself and a friend at a restaurant, then quickly upload it to her MySpace or Facebook page, with a link to the restaurant website. This instantly adds a greater marketing value to the restaurant in marketing to its future customers. The restaurant now has had a user-generated media item posted on the Internet that might be seen by many of this customer's friends, family, coworkers, etc.

Thus, according to some embodiments of the invention, a recommendation may comprise a literal recommendation, a photo relating to provider 240, a hyperlink to such a photo, a report or a blog post referring to provider 240, as well as referring hyperlink 110 itself. According to some embodiments of the invention, the picture/hyperlink may be tracked by dedicated network server 100. The tracking may include in addition to the social network website id number also the user id number (who posted the link). The target (restaurant website) may decide voluntary to compensate the social network website and the user for the referral. Dedicated network server 100 then collects the compensation from target user 230 and distributes it to the social network and/or the users. The social network may decide to distribute part of the compensation to the users themselves. The compensation may be money, a coupon, discount, a free service, a product, a sample, a rebate, credit points or other combinations or methods. For example, target user 230 may decide to compensate the social network with money and the user with a coupon creating two levels of compensations, the website level and the user level. In this way, the compensation may be split between the hosting website and the user.

According to some embodiments of the invention, the disclosed systems and methods may generate chains of websites that are linked via referring hyperlinks 110. Dedicated network server 100 may be arranged to track referring hyperlinks 110, recommendations and transactions over several websites (source websites 120 and target websites 130 in sequential referring hyperlinks 110).

According to some embodiments of the invention, dedicated network server 100 may further generate or suggest the generation of connections in social network 109 based upon referring hyperlinks 110.

According to some embodiments of the invention, a large scale operator of dedicated network server 100 tracking system may obtain valuable information on hyperlinks structure and what users click on websites. Click tracking is valuable for behavioral targeting, web activity analysis, and search engine page ranking. Most of the search engines use a hyperlink structure to determine reputation and importance. A site's ranking in search results is partly based on analysis of those sites that link to it. Link-based analysis is a useful way of measuring a site's value, and has improved the quality of web searches. Both the quantity and, more importantly, the quality of links count towards this rating. Valid hyperlinks for page rank are non-paid links (organic/natural/editorial), and not paid links. Search engines try to recognize paid links and disregard them in page rank because they may influence the quality of link-based reputation and make it harder for the search engines to return relevant results.

According to some embodiments of the invention, dedicated network server 100 as an operator of the network has control over organic links (not just the static linking but also the dynamic one, the clicks on those links) and as a result is in a position to provide a better page rank and better quality of web search results. For example, dedicated network server 100 can require source websites 120 to not include any paid links in the system by contract, unlike search engine which does not have the capability to do that, or to include paid links but to tag them as such.

According to some embodiments of the invention, the system and method implements an implicit bidding/auction method, in which source websites 120 “sell” their referring hyperlinks 110 to targets for free with the expectation of voluntary compensation. Target websites 130 review referrals data (clicks, sales) and decide which referrer to compensate and how much. After receiving compensation, owners 121 of source websites 120 may compare the compensation they received to other similar targets' compensation. Source websites 120 may use this information when putting new links on their sites or changing existing links. Target websites 130 can compare their compensation to other similar targets and may decide to change their compensations upon this information. Using the comparable reporting of tracking and compensation data, source websites 120 and target websites 130 may drive the compensation of the social driven implicit auction to a level comparable to an explicit auction. Target websites 130 who pays the most (not by explicit auction, or in advance but by history of payments) may lead in links and promoters while the one who is not actively participating may have fewer or no links and promoters. Periodic or trend reports may include page view, clicks, unique visitors, time on the site and demographic data from referrers to targets. Aggregate page view report and clicks from all source websites 120 to target websites 130, even if they are not part of the system may be used to apply social pressure to encourage others to join. Other reports may include payment from each target websites 130 to source websites 120, aggregate payment from owners 131 of each target websites 130 to all source websites 120, compensation comparison between target websites 130 that include: total compensation, average compensation per click, per sale etc., and reports to target websites 130 what other similar targets to its site and competitors' sites are compensating and a suggest compensation amount.

According to some embodiments of the invention, dedicated network server 100 may use any suitable tracking method to track impressions, clicks, sales, or other events, for example, from target websites 130. Dedicated network server 100 generates referral reports to target website 130 and source websites 120, collects the contributions, distributes the contributions to owners 121 of source websites 120, generates contribution reports to source website 120 and generates comparable benefit reports to source websites 120 and target website 130.

According to some embodiments of the invention, dedicated network server 100 may generate an improved web link graph of static and dynamic structure (traffic and value) of organic hyperlinks and connections between source websites 120 and target websites 130 in a network. The web link graph may be presented on GUI 114 and allow users and owner receive information and determine benefits on the basis of the graph and related features and analysis of the data. The web link graph may be used in the decision supporting module to assist target websites 130 in the benefit value evaluation process.

Benefit value evaluation module 105 may be based in part on analyzing the graph structure of source websites 120 (web pages) and target websites 130. The web link graph may have nodes that represent the web pages and referring hyperlinks 110 between the nodes, the hyperlinks representing different relationships between the nodes in each graphical representation including activations (clicks), page views, transactions on target website and transferred benefit values for example. Dedicated network server 100 may further generating a classifier and ranking based on the graph model, and use it in assigning a new suggested value to referring hyperlinks 110 and in importance, trust and quality ranking in search engine page rank or social networks for example. For example, higher total transferred benefits to a web page (website) may result in greater ranking for importance, trust, quality and assigning higher suggested values for that web page. The popularity of source websites 120 and of target websites 130 may affect the suggested benefits for referring hyperlinks 110 between them.

Advantageously, the network effect of the system may be creating relations and value numbers for each link and website which describe its worthiness to be used in web link analysis and social structure analysis. The system may further be used to automatically separate useful webpages from spam. A web page with higher link worthiness is better than a web page with lower link worthiness.

According to some embodiments of the invention, one advantage of organic hyperlinks over paid links (ads) is that they are voluntarily part of the content of a website. Organic links implicitly promote the linked website by being counted by search engines and included in the page rank, or a vote of support as such. Another advantage of organic links is that the user is directed to a website which the user is interested in visiting. Still another advantage of organic natural links over paid links is that organic links last as long as the website exists, but paid ads only last as long as they are paid for. Additionally, ads are subject to ad blocking software, which recognizes ads and prevents them from being displayed on the user's computer.

Newspapers find themselves in hard time in the Internet era, their printed circulations are decreasing while online presence does not offset their declining revenues. While it is impossible to monetize a printed article which mentions a target which then directs customers to that target, an online article which mentions the same target and drives a lot of users to target website 130 can be tracked and reported to the target with an opportunity to be compensated for that traffic. Another advantage for the referring is that the referring may be compensated for hyperlinks that otherwise he cannot be compensated. For example, a blogger who writes an editorial article in his blog may be compensated for the editorial links in his article.

According to some embodiments of the invention, a target who joins dedicated network server 100 does not need to deal directly with any of source websites 120 that are referring users to him. Moreover there is no obligation on him to compensate any of source websites 120. Target website 130 may decide how to divide the total compensation between source websites 120. For example, target website 130 may decide to divide a total compensation among the source websites 120 in proportion to the traffic, page view, clicks and sales received from each source websites 120.

According to some embodiments of the invention, the present invention encourages implicit auction (bidding) by allowing all the participants to know comparable benefits and compensations (in absolute or proportional terms) from any target website 130 to any source website 120. A target that will compensate the most will attract source websites 120 while a target who compensate a little will be less attractive for source websites 120.

According to some embodiments of the invention, the data processing system comprises dedicated network server 100 comprising application 102, database 104, benefit transaction network platform 108, and a decision-supporting module 103. Application 102 is arranged to monitor activation of referring hyperlinks 110; collect transactional information from target website 130; record the transactional information such as to relate it to the activation of referring hyperlinks 110; monitor user actions in source websites 120 and in target websites 130; analyze the transactional information in relation to the user actions; and assign a suggested value to referring hyperlinks 110 in relation to the user actions and activation of referring hyperlinks 110; and transactional information and target websites 130. Database 104 is arranged to receive data relating to the monitored activation of referring hyperlinks 110, monitored user actions, and transactional information. Benefit transaction network platform 108 is arranged to support transferal of benefits having benefit values from target website owners 131 to source website owners 121, wherein the benefit value is based on the monitored activation of referring hyperlinks 110 and the assigned suggested value. Decision supporting module 103 is associated with benefit value evaluation module 105 and benefit transaction network platform 108 and arranged to provide target owner 131 with the data relating the process of to the assigning the suggested value, assisting the target web site owner 131 to determine the benefit values in relation to a conduct code relating to voluntary compensation behavioral patterns.

Benefit transaction network platform 108 is associated with dedicated network server 100 and arranged to allow source website owners 121 and target website owners 131 to benefit each other. The predefined rules relate to characteristics of target websites 130, source websites 120 and statistical data relating to past transactional information and suggested values. The suggested value is assigned as an estimate of and a recommendation for the benefit values.

According to some embodiments of the invention, users may interact in various ways with source websites 120. According to a first embodiment, users sign to dedicated network server 100 and get an ID. Whenever users want to put a hyperlink on source website 120 they first use the system to convert it to a special hyperlink. They put this special hyperlink on source website 120. When a user clicks on this special hyperlink, he is redirected through dedicated network server 100 that record the click, associate it with the user and direct it to the target with the original hyperlink. The target website 130 compensates the specific user for that traffic. According to a second embodiment, users sign with source websites 120 and dedicated network server 100. Users put a hyperlink on source website 120. When a user (other user) clicks on this hyperlink, he is redirected through dedicated network server 100 that records the click, associate it with source website 120 and user and direct it to target website 130. Target website 130 may compensate the specific user for that traffic, or target website 130 may compensate source website 120, and source website 120 may compensate the specific user (revenue share) for that traffic using reports from dedicated network server 100 or let dedicated network server 100 to compensate source website 120 and users through revenue sharing. According to a third embodiment, users sign with source website 120. Users put a hyperlink on source website 120. When (another) user clicks on this hyperlink, he is redirected through dedicated network server 100 that records the click, associate it with source website 120 and user and direct it to target website 130. Target website 130 compensates source website 120 for that traffic. Source website 120 may compensate the specific user using reports from dedicated network server 100. According to a forth embodiment, content/hyperlinks owners sign with source website 120 and dedicated network server 100. Source website 120 put a hyperlink/content on source website 120 taken from content/hyperlink owner. When a user clicks on this hyperlink, he is redirected through dedicated network server 100 that records the click, associate it with source website 120 and the content owner and direct it to target website 130. Target website 130 compensates source website 120 for that traffic. Source website 120 compensates the content owner through dedicated network server 100 or directly in a revenue share model.

Advantageously, by allowing users to share in the revenue generated by their hyperlinks on source websites 120, source websites 120 are encouraging users to be more engaged.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A data processing system for monetizing referring hyperlinks from a plurality of source websites associated with source website owners to a plurality of target websites associated with target website owners, wherein the source website owners and target web site owners are not associated in business relationship related to referrals, the data processing system comprising:
a dedicated network server comprising:
a monitoring module arranged to monitor and record activation of the referring hyperlinks; and
a benefit value evaluation module, arranged to assign a suggested value to the referring hyperlinks based on (i) predefined rules, the predefined rules relating to the activation of the referring hyperlinks, (ii) characteristics of the target websites and the source websites, and (iii) statistical data relating to past activation of the referring hyperlinks and related transferred benefit values;
and
a benefit transaction network platform arranged to support transferal of benefits having benefit values from the target website owners to the source website owners, wherein the benefit value is determined by the owner of the target website after the activation of the referring hyperlinks,
wherein the suggested value is assigned as an estimate of and a recommendation for the determination of the benefit values.

2. The data processing system of claim 1, wherein the suggested value is assigned in relation to external sources for rating websites.

3. The data processing system of claim 1, wherein the past activation of referring hyperlinks comprises activation of referring hyperlinks in various source websites to different target websites.

4. The data processing system of claim 1, wherein the monitoring module is further arranged to collect transactional information from the target website, and wherein the predefined rules, the statistical data and the benefit value further relate to the transactional information, wherein the evaluation module is further arranged to analyze the transactional information in relation to the user actions, and wherein the dedicated network server further comprises a database arranged to receive data relating to the monitored user actions and the transactional data.

5. The data processing system of claim 1, further comprising a decision supporting module associated with the benefit value evaluation module and the benefit transaction network platform and arranged to provide the target website owner with the data relating the process of assigning the suggested value, assisting the target web site owner to determine the benefit values in relation to a conduct code relating to voluntary compensation behavioral patterns.

6. The data processing system of claim 1, wherein benefits comprise at least one of: a monetary payment, a reciprocal service, a coupon, and non-monetary payment.

7. The data processing system of claim 1, wherein dedicated network server further comprises a statistical analysis module arranged to collect and analyze the statistical data relating to past activation of the referring hyperlinks of various target websites and source websites.

8. The data processing system of claim 1, wherein the dedicated network server further comprises a database arranged to receive data relating to the monitored activation of referring hyperlinks.

9. The data processing system of claim 1, wherein the referring hyperlinks were edited by specific users within the source website, and wherein the benefit transaction network platform is further arranged to support transferal of benefits having benefit values from the target website owners to the specific users.

10. The data processing system of claim 9, wherein the benefit value is transferred to the specific users through the source website owners.

11. The data processing system of claim 1, wherein the dedicated network server further comprises a graphical user interface arranged to present a web link graph comprising connections and benefit transactions between source websites and target websites.

12. A data processing system for monetizing referring hyperlinks from a plurality of source websites associated with source website owners to a plurality of target websites associated with target website owners, wherein the source website owners and target web site owners are not associated in business relationship related to referring hyperlinks, and wherein the referring hyperlinks were edited by specific users within the source website, the data processing system comprising:
a dedicated network server comprising:
a monitoring module arranged to monitor and record activation of the referring hyperlinks;
a benefit value evaluation module, arranged to assign a suggested value to the referring hyperlinks based on (i) predefined rules, the predefined rules relating to the activation of the referring hyperlinks, (ii) characteristics of the target websites and the source websites, and (iii) statistical data relating to past activation of the referring hyperlinks and related transferred benefit values; and
a benefit transaction network platform arranged to support transferal of benefits having benefit values from the target website owners to the specific users, wherein the benefit value is determined by the owner of the target website after the activation of the referring hyperlinks,
wherein the suggested value is assigned as an estimate of and a recommendation for the determination of the benefit values.

13. A computer-implemented method of monetizing referring hyperlinks from a plurality of source websites associated with source website owners to a plurality of target websites associated with target website owners, wherein the source website owners and target web site owners are not associated in business relationship related to referring hyperlinks, the computer-implemented method comprising:
monitoring activation of the referring hyperlinks;
assigning a suggested value to the referring hyperlinks based on predefined rules;
enabling the target web site owner to determine a benefit value related to the referring hyperlinks of a specific source web site, wherein the benefit value relates to the suggested values and is determined after the activation of the referring hyperlinks; and
providing a benefit transaction network platform supporting transferal of benefits having benefit values from the target website owners to the source website owners, wherein the benefit value is based on the monitored activation of the referring hyperlinks and the assigned suggested value,
wherein the predefined rules relate to characteristics of the target websites and the source websites as well as to past activation of the referring hyperlinks, and
wherein the suggested value is assigned as an estimate of and a recommendation for the benefit values.

14. The computer-implemented method of claim 13, wherein the monitoring activation of the referring hyperlinks is carried out by the target websites.

15. The computer-implemented method of claim 13, wherein the monitoring activation of the referring hyperlinks is carried out by setting an application in the source websites.

16. The computer-implemented method of claim 13, further comprising generating reports comprising the monitored activation of the referring hyperlinks.

17. The computer-implemented method of claim 13, further comprising associating source website owners and target website owners in a social network and enhancing the supported benefit transferal.

18. The computer-implemented method of claim 13, further comprising:
collecting transactional information from the target websites, the transactional information comprising benefits to the target websites; and
analyzing the transactional information such as to relate the transactional information to the activation of the referring hyperlinks,
wherein the predefined rules further relate to statistical data relating to past transactional information and suggested values.

19. The computer-implemented method of claim 18, further comprising:
monitoring user actions in the source websites and in the target websites; and
analyzing the transactional information in relation to the user actions,
wherein the collecting transactional information from the target websites is further related to the monitored user actions,
wherein the benefits relate to the user actions, and
wherein analyzing the transactional information comprises statistically analyzing all transactional information from the plurality of target websites in relation to target website characteristics.

20. The computer-implemented method of claim 19, wherein the monitoring user actions is carried out by setting a tracking cookie on a browser application of the user.

21. The computer-implemented method of claim 19, wherein the monitoring user actions is carried out by setting an application in the source websites and in the target websites.

22. The computer-implemented method of claim 13, further comprising generating benefit transaction graphs that illustrate graphically connections and benefit transactions between the source websites and the target website.

23. A data processing system for monetizing referring hyperlinks from a plurality of source websites associated with source website owners to a plurality of target websites associated with target website owners, wherein the source website owners and target web site owners are not associated in business relationship related to referring hyperlinks, the data processing system comprising:
a dedicated network server comprising:
an application arranged to: monitor activation of the referring hyperlinks; collect transactional information from the target website; record the transactional information such as to relate it to the activation of the referring hyperlinks; monitor user actions in the source websites and in the target websites; analyze the transactional information in relation to the user actions; and assign a suggested value to the referring hyperlinks in relation to the user actions and activation of the referring hyperlinks, the transactional information, predefined rules, external sources, past benefits and the target websites;
a database arranged to receive data relating to the monitored activation of referring hyperlinks, monitored user actions, and transactional information;
a benefit transaction network platform arranged to support transferal of benefits having benefit values from the target website owners to the source website owners, wherein the benefit value is based on the monitored activation of the referring hyperlinks and the assigned suggested value;
a decision supporting module associated with the benefit value evaluation module and the benefit transaction network platform and arranged to provide the target owner with the data relating the process of assigning the suggested value, assisting the target web site owner to determine the benefit values in relation to a conduct code relating to voluntary compensation behavioral patterns;
a transactional platform associated with the dedicated network server and arranged to allow source website owners and target website owners to benefit each other; and
a graphical user interface arranged to present a web link graph comprising connections and benefit transactions between source websites and target websites,
wherein the predefined rules relate to characteristics of the target websites, the source websites and statistical data relating to past transactional information and suggested values, and related transferred benefit values,
wherein the suggested value is assigned as an estimate of and a recommendation for the benefit values.
